(19) United States
(12) Patent Application Publication
(10) Pub. No.: US 2005/0035909 A1
(43) Pub. Date: Feb. 17, 2005

(54) Card device having S-shaped printed antenna

(76) Inventor: Wen Hsiung Lin, Hsin Chuang City (TW)

Correspondence Address: Wen Hsiung Lin, P.O. Box 4-67, Hsin Chuang, Taipei, 242, TW

(21) Appl. No.: 10/643,381

(22) Filed: Aug. 16, 2003

(51) Int. Cl. H01Q 1/38

(52) U.S. Cl. 343/700 MS; 343/850

(57) ABSTRACT

A card device includes one or more antenna devices printed on a board member and each having an S-shaped structure formed by a peripheral segment and a link segment, for sending or receiving wireless signals or for wireless transmission purposes, and for allowing the antenna device to be easily printed and applied onto the board member of the card device without additional securing or welding or assembling processes. Each of the antenna devices includes a conductor printed around the S-shaped antenna device to form an S-shaped hollow space in the antenna device.

### BACKGROUND OF THE INVENTION

1. Field of the Invention

The present invention relates to a circuit board or a card device, and more particularly to a circuit board or a card device having a printed antenna device, such as an S-shaped antenna device.

2. Description of the Prior Art

Typical circuit boards or card devices comprise a separate antenna device secured thereon or coupled thereto with fasteners or by welding processes, for sending or receiving wireless signals or for wireless transmission purposes.

For example, U.S. Pat. No. 6,034,636 to Saitoh, and U.S. Pat. No. 6,255,994 B1 to Saito disclose two of the typical circuit boards or card devices having a separate antenna device secured thereon or coupled thereto with fasteners or by welding processes. However, it takes time or processes to attach or secure the separate antenna device onto the typical circuit boards or card devices.

The present invention has arisen to mitigate and/or obviate the afore-described disadvantages of the conventional antenna devices for circuit boards or card devices.

### SUMMARY OF THE INVENTION

The primary objective of the present invention is to provide a circuit board or a card device having an antenna device printed thereon for sending or receiving wireless signals or for wireless transmission purposes, and for allowing the antenna device to be easily printed and applied onto the circuit board or the card device without additional securing or welding or assembling processes.

The other objective of the present invention is to provide a circuit board or a card device having an S-shaped and printed antenna device printed and applied thereon, and formed by a peripheral segment and a link segment, for directing purposes.

In accordance with one aspect of the invention, there is provided a card device comprising a board member, and at least one antenna device printed on the board member, the antenna device includes an S-shaped structure having a first segment and a second segment coupled together to form the S-shaped structure, and for sending or receiving wireless signals or for wireless transmission purposes, and for allowing the antenna device to be easily printed and applied onto the board member of the card device without additional securing or welding or assembling processes.

The antenna device includes a conductor provided around the S-shaped antenna device to form a S-shaped hollow space in the antenna device.

The board member includes a transmission circuit provided thereon, and the antenna device includes an output terminal coupled to the transmission circuit. The antenna device includes a peripheral segment having two openings formed therein and each defined by two ends, and a link segment coupled between two of the ends of the peripheral segment to form the S-shaped structure.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a circuit board or a card device having an S-shaped antenna device in accordance with the present invention;

FIG. 2 is a perspective view illustrating the operation of the printed antenna device for the circuit board or card device;

FIG. 3 is a plan schematic view illustrating the operation of the printed antenna device for the circuit board or card device; and

FIG. 4 is a diagram illustrating the frequencies of the antenna device of the circuit board or the card device.

### DETAILED DESCRIPTION OF THE PREFERRED EMBODIMENT

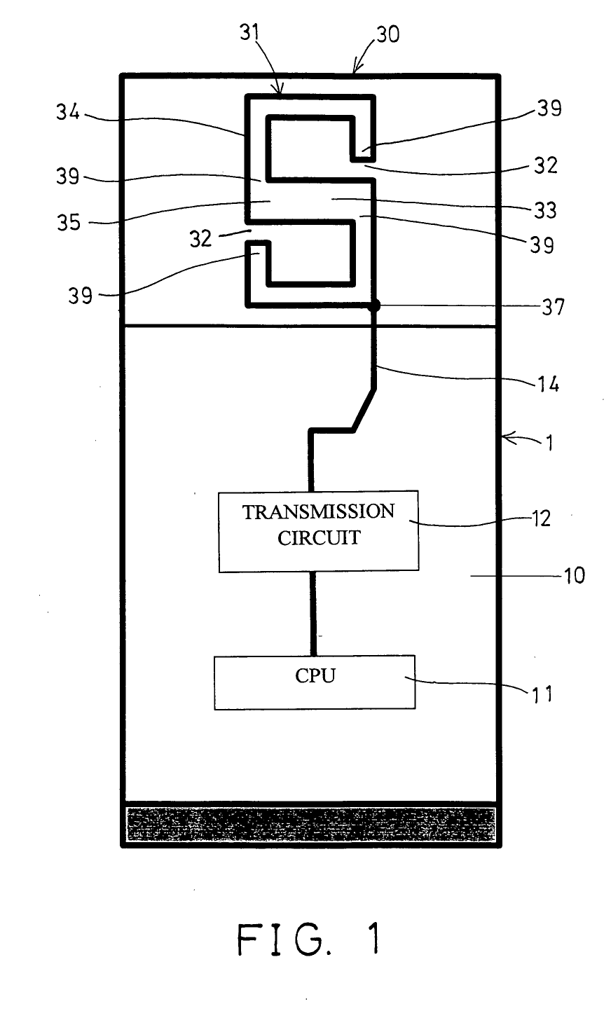

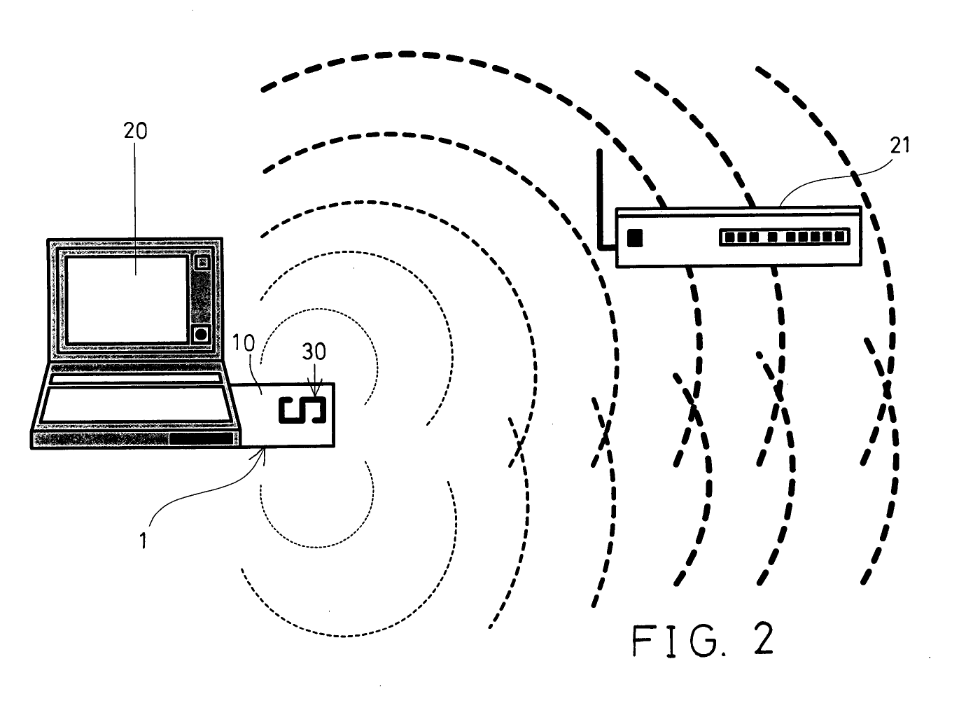

Referring to the drawings, and initially to FIGS. 1 and 2, a circuit board or a card device 1, such as a wireless card device 1 in accordance with the present invention comprises a board member 10 having one edge for plugging or coupling to computer facilities 20 of the end users, and comprises one or more antenna devices 30 printed on the board member 10 for wireless transmission purposes, or for sending or receiving wireless signals to or from a wireless access device 21 of a network system or the like.

As shown in FIG. 1, the card device 1 includes a processor device or a central processing unit 11, and a wireless control or transmission circuit 12, and/or other circuits or elements provided or attached on the board member 10, and electrically connected together, for wirelessly communicating with the wireless access devices 21 of various wireless network systems or the like.

The card device 1 further includes one or more antenna devices 30 printed or applied on the board member 10, and electrically coupled to the wireless control or transmission circuit 12 with a wire, cable, or terminal or printed conductor 14, or the like. For example, the card device 1 may include one or more, such as three antenna devices 30 printed or applied on the board member 10.

It is to be noted that the antenna device 30 and/or the conductor 14 may be printed or applied onto the board member 10 of the card device 1 by printed circuit board manufacturing processes, for allowing the antenna devices 30 and the conductor 14 to be printed or applied onto the board member 10 of the card device 1 without additional fastening or securing or assembling processes.

Each of the antenna devices 30 includes a peripheral segment 31 having two opposite or anti-symmetric notches or openings 32 formed therein and each defined by two ends 39, and a link segment 33 laterally coupled between two of the ends 39 of the peripheral segment 31 to form an S-shaped structure or configuration.

It is preferable that each of the antenna devices 30 includes a cable-like conductor 34 applied or printed around the S-shaped configuration of the antenna device 30 or applied on the outer peripheral portion of the antenna device 30, in order to form or define an S-shaped hollow space 35 in the antenna device 30.

Each of the antenna devices 30 includes an output terminal 37 coupled to the wireless control or transmission circuit 12 with such as the printed conductor 14.

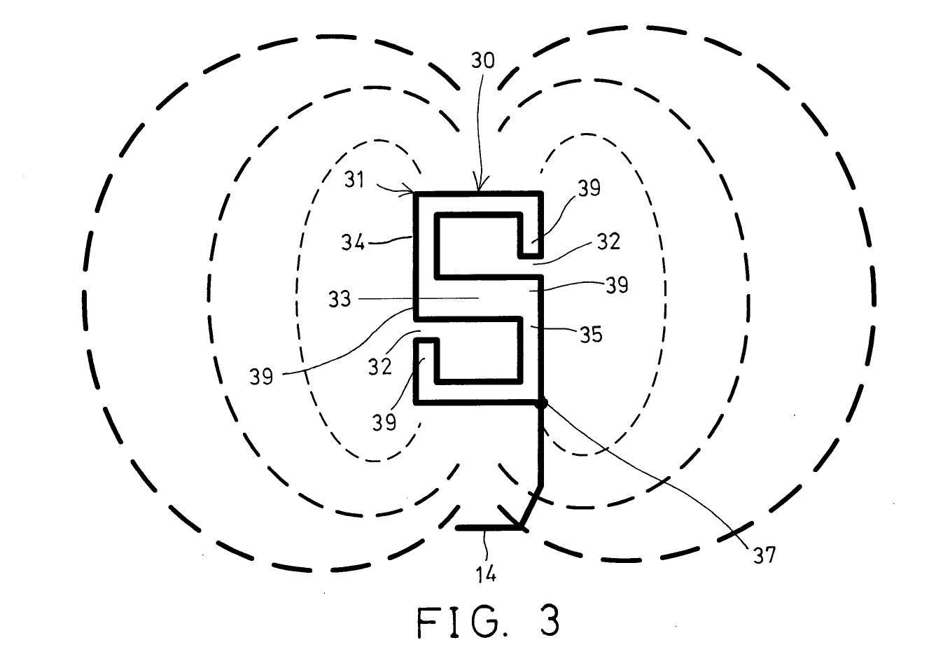

In operation, as shown in FIGS. 2, 3, the peripheral segment 31 and/or the link segment 32 of each of the antenna device 30 may be directed to predetermined directions, and may thus be provided to receive and transmit signals to or from the predetermined directions.

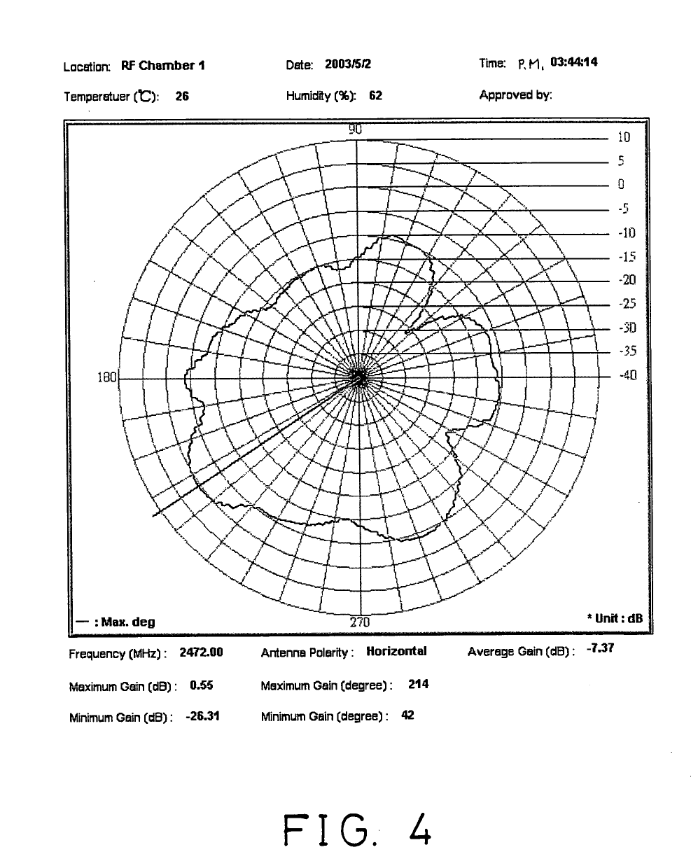

For example, as shown in FIG. 4, illustrated is the distribution of the frequencies generated by the antenna device 30.

It is to be noted that the peripheral segment 31 and the link segment 32 of each of the antenna device 30 may be provided for receiving and/or transmitting the signals of the different frequencies, such as the different frequencies provided by IEEE 802.11a, IEEE 802.11b, IEEE 802.11e, IEEE 802.11g, etc. or other frequencies.

It is further to be noted that the cable-like conductors 34 of the antenna devices 30 may be easily and precisely printed and applied onto the circuit board or the card device 1 without additional securing or welding or assembling processes.

Accordingly, the card device includes an S-shaped antenna device for sending or receiving wireless signals or for wireless transmission purposes, and for allowing the antenna device to be easily printed and applied onto the circuit board or the card device without additional securing or welding or assembling processes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A card device comprising:
a board member, and
at least one antenna device printed on said board member, said at least one antenna device including an S-shaped structure.

2. The card device as claimed in claim 1, wherein said at least one antenna device includes a conductor provided around said S-shaped antenna device to form an S-shaped hollow space in said at least one antenna device.

3. The card device as claimed in claim 1, wherein said board member includes a transmission circuit provided thereon, and said at least one antenna device includes an output terminal coupled to said transmission circuit.

4. The card device as claimed in claim 1, wherein said at least one antenna device includes a peripheral segment having two openings formed therein and each defined by two ends, and a link segment coupled between two of said ends of said peripheral segment to form said S-shaped structure.
